(19) United States
(12) Patent Application Publication
(10) Pub. No.: US 2021/0371595 A1
(43) Pub. Date: Dec. 2, 2021

(54) ELASTOMERIC COPOLYMERS WITH A HIGH SULFUR CONTENT AND PROCESS FOR THEIR PREPARATION

(71) Applicants: ENI S.P.A., Roma (IT); CONSIGLIO NAZIONALE DELLE RICERCHE, Roma (IT)

(72) Inventors: Alberto Renato De Angelis, San Donato Milanese (IT); Laura Boggioni, Abbiategrasso (IT); Simona Losio, Garbagnate Milanese (IT)

(21) Appl. No.: 17/052,881

(22) PCT Filed: May 10, 2019
(86) PCT No.: PCT/EP2019/062010

§ 371 Date: Nov. 4, 2020

(30) Foreign Application Priority Data
May 11, 2018 (IT) 102018000005276

(51) Int. Cl. C08G 75/14; B29C 39/00; B29C 39/38

(52) U.S. Cl. CPC C08G 75/14; B29C 39/006; B29K 2105/0002; C08G 2380/00; C08G 2330/00; B29C 39/38

(57) ABSTRACT

Elastomeric copolymer with a high sulfur content, comprising sulfur in a quantity higher than or equal to 40% by weight, preferably ranging from 55% by weight to 90% by weight, with respect to the total weight of said elastomeric copolymer, and at least one monomer having general formula (I): CH₂═CH—(CH₂)_{y}-(X)ₙ-(X)ₘ-(CH₂)ₓ—CH═CH₂ (I) wherein: X represents a sulfur atom, a selenium atom, a tellurium atom, preferably a sulfur atom, a selenium atom; y and x, equal to or different from one another, are a whole number ranging from 0 to 4; n and m, equal to or different from one another, are a whole number ranging from 0 to 3, at least one of n and m being equal to 1; said monomer being present in a quantity lower than or equal to 60% by weight, preferably ranging from 10% by weight to 45% by weight, with respect to the total weight of said elastomeric copolymer; provided that, in the case wherein in said general formula (I) X is sulfur, y and x are 1, at least one of n and m must be different from 1 and the sum of n+m must be different from 1. Said elastomeric copolymer with a high sulfur content can be advantageously used in a great many applications such as, for example, thermal insulation, conveyor

The present invention relates to an elastomeric copolymer with a high sulfur content.

More particularly, the present invention relates to an elastomeric copolymer with a high sulfur content comprising sulfur in a quantity higher than or equal to 40% by weight, preferably ranging from 55% by weight to 90% by weight, with respect to the total weight of said elastomeric copolymer, and at least one monomer selected from allyl chalcogenides, said monomer being present in a quantity lower than or equal to 60% by weight, preferably ranging from 10% by weight to 45% by weight, with respect to the total weight of said elastomeric copolymer.

The present invention also relates to a process for the preparation of said elastomeric copolymer with a high sulfur content.

Said elastomeric copolymer with a high sulfur content can be advantageously used in a great many applications such as, for example, thermal insulation, conveyor belts, transmission belts, flexible hoses, elastomeric compositions for tyres.

It is well known that in the oil industry, during the production of natural gas and oil, increasingly large quantities of elemental sulfur are produced, the production surplus of which currently exceeds one million tonnes per year, with a tendency to further increase as new fields are developed in which the content of hydrogen sulphide (H₂S) and elemental sulfur will become more and more significant. The world production surplus of sulfur not only causes a depression in the market price thereof, so that transport costs can have a negative impact on its marketing, but also causes significant environmental problems due to the storage of large quantities of elemental sulfur. In fact, if the storage is performed in the open air or underground, the aggression of atmospheric agents can cause the contamination of the surrounding areas. In this regard, it is worth mentioning, for example, the phenomenon known as “dusting” or dispersion of sulfur powder which, in turn, through oxidation can produce acidic substances (for example, sulfuric acid).

Studies have been carried out with the aim of using elemental sulfur for the preparation of copolymers with a high sulfur content.

For example, the US patent application 2014/0199592 describes a polymeric composition comprising a sulfur copolymer, in a quantity of at least approximately 50% by weight with respect to the copolymer, and one or more monomers selected from the group consisting of ethylenically unsaturated monomers, epoxy monomers, thiirane monomers, in a quantity ranging from about 0.1% by weight to about 50% by weight with respect to the copolymer. The above mentioned polymeric composition with a high sulfur content is said to be advantageously usable in electrochemical cells and optical elements.

Khaway S. Z. et al., in “Material Letters” (2017), Vol. 203, pages 58-61, describe the preparation of flexible copolymers with a high sulfur content obtained through the reverse vulcanization technique by reacting sulfur and diallyl disulfide. These copolymers are said to have good transparency, high flexibility due to their low glass transition temperature (T_{g}), a very low Young modulus and high tensile strain at break. In addition, the aforementioned copolymers are said to be advantageously usable as thermal insulators or as optical materials transparent in infrared light.

Since, as mentioned above, there is a surplus of sulfur production worldwide, the use of sulfur for the production of new copolymers with a high sulfur content, in particular new elastomeric copolymers with a high sulfur content, is still of great interest.

The Applicant therefore posed the problem of finding new elastomeric copolymers with a high sulfur content having low glass transition temperatures (T_{g}) and good elastic properties, in particular in terms of elongation at break.

The Applicant has now found elastomeric copolymers with a high sulfur content comprising sulfur in a quantity higher than or equal to 40% by weight, preferably ranging from 55% by weight to 90% by weight, with respect to the total weight of said elastomeric copolymer and at least one monomer selected from allyl chalcogenides, said monomer being present in a quantity lower than or equal to 60% by weight, preferably ranging from 10% by weight to 45% by weight, with respect to the total weight of said elastomeric copolymer, having a low glass transition temperature (T_{g}) and good elastic properties, in particular in terms of elongation at break. Said elastomeric copolymers with a high sulfur content, thanks to their features, can be advantageously used in a great many applications such as, for example, thermal insulation, conveyor belts, transmission belts, flexible hoses, elastomeric compositions for tyres.

Therefore, the subject of the present invention is an elastomeric copolymer with a high sulfur content comprising sulfur in a quantity higher than or equal to 40% by weight, preferably ranging from 55% by weight to 90% by weight, with respect to the total weight of said elastomeric copolymer, and at least one monomer having general formula (I):

CH₂═CH—(CH₂)_{y}-(X)ₙ-(X)ₘ-(CH₂)ₓ—CH═CH₂ (I)

wherein:

X represents a sulfur atom, a selenium atom, a tellurium atom, preferably a sulfur atom, a selenium atom;

y and x, equal to or different from one another, are a whole number ranging from 0 to 4;

n and m, equal to or different from one another, are a whole number ranging from 0 to 3, at least one of n and m being equal to 1;

said monomer being present in a quantity lower than or equal to 60% by weight, preferably ranging from 10% by weight to 45% by weight, with respect to the total weight of said elastomeric copolymer;
provided that, in the case wherein, in said general formula (I) X is sulfur, y and x are 1, at least one of n and m must be different from 1 and the sum of n+m must be different from 1.

For the purpose of the present description and of the following claims, the definitions of the numerical ranges always include the extremes unless otherwise specified.

For the purpose of the present description and of the following claims, the term “comprising” also includes the terms “which essentially consists of” or “which consists of”.

According to a preferred embodiment of the present invention, said monomer having general formula (I) can be selected, for example, from diallyl diselenide, essential oil of garlic, divinyl disulphide, or mixtures thereof.

In accordance with a preferred embodiment of the present invention, said elastomeric copolymer with a high sulfur content comprises sulfur in a quantity equal to 70% by weight with respect to the total weight of said elastomeric copolymer, and at least one monomer having general formula (Ia):

CH₂═CH—(CH₂)_{y}-(X)ₙ-(X)ₘ-(CH₂)ₓ—CH═CH₂ (I)

wherein:

X represents a selenium atom; p y is 1;

x is 1;

n is 1;

m is 1;

said monomer being present in a quantity equal to 30% by weight with respect to the total weight of said elastomeric copolymer.

In accordance with a further preferred embodiment of the present invention, said elastomeric copolymer with a high sulfur content comprises sulfur in a quantity equal to 70% by weight with respect to the total weight of said elastomeric copolymer and a mixture of monomers having general formula (Ib):

CH₂═CH—(CH₂)_{y}-(X)ₙ-(X)ₘ-(CH₂)ₓ—CH═CH₂ (Ib)

wherein:

X represents a sulfur atom;

y is 1;

x is 1;

n is 0 or 1;

m is 1 or 2;

said mixture of monomers being present in a quantity equal to 30% by weight with respect to the total weight of said elastomeric copolymer.

In accordance with a further preferred embodiment of the present invention, said elastomeric copolymer with a high sulfur content comprises sulfur in a quantity equal to 80% by weight with respect to the total weight of said elastomeric copolymer and at least one monomer having general formula (Ic):

CH₂═CH—(CH₂)_{y}-(X)ₙ-(X)ₘ-(CH₂)ₓ—CH═CH₂ (Ic)

wherein:

X represents a sulfur atom;

y is 0;

x is 0;

n is 1;

m is 1;

said monomer being present in a quantity equal to 20% by weight with respect to the total weight of said elastomeric copolymer.

In accordance with a further preferred embodiment of the present invention, said elastomeric copolymer with a high sulfur content comprises sulfur in a quantity equal to 70% by weight with respect to the total weight of said elastomeric copolymer, and at least one monomer having general formula (Ic):

CH₂═CH—(CH₂)_{y}-(X)ₙ-(X)ₘ-(CH₂)ₓ—CH═CH₂ (Ic)

wherein:

X represents a sulfur atom;

y is 0;

x is 0;

n is 1;

m is 1;

said monomer being present in a quantity equal to 30% by weight with respect to the total weight of said elastomeric copolymer.

In accordance with a preferred embodiment of the present invention, said elastomeric copolymer with a high sulfur content may have a glass transition temperature (T_{g}) higher than or equal to −20° C., preferably ranging from −18° C. to −10° C.

Said glass transition temperature (T_{g}) was determined by DSC (Differential Scanning calorimetry) thermal analysis, which was carried out as described in the paragraph “Analysis and characterisation methodology” below reported.

In accordance with a preferred embodiment of the present invention, said elastomeric copolymer with a high sulfur content may have an elongation at break higher than or equal to 55%.

Said elongation at break was determined in accordance with the ISO 37:2017 standard.

As mentioned above, the present invention also relates to a process for the preparation of said elastomeric copolymer with a high sulfur content.

Consequently, a further subject of the present patent application is a process for the preparation of an elastomeric copolymer with a high sulfur content comprising:

(i) melting the sulfur at a temperature ranging from 110° C. to 190° C., preferably ranging from 120° C. to 170° C., for a time ranging from 1 minute to 15 minutes, preferably ranging from 2 minutes to 12 minutes, obtaining sulfur in liquid form;
(ii) reacting the sulfur in liquid form obtained in stage (i) with at least one monomer having general formula (I) at a temperature ranging from 110° C. to 190° C., preferably ranging from 120° C. to 170° C., for a time ranging from 1 minute to 15 minutes, preferably ranging from 2 minutes to 10 minutes, obtaining a liquid pre-polymer;
(iii) pouring the liquid pre-polymer obtained in stage (ii) into a mould and maintaining said mould at a temperature ranging from 100° C. to 150° C., preferably ranging from 110° C. to 130° C., for a time ranging from 1 hour to 20 hours, preferably ranging from 2 hours to 15 hours, obtaining an elastomeric copolymer with a high sulfur content.

In accordance with a preferred embodiment of the present invention the sulfur used in said stage (i) is elemental sulfur.

For the purpose of the process which is the subject of the present invention, this elemental sulfur is preferably in powder form. Under ambient conditions (i.e. at ambient temperature and pressure), the elemental sulfur exists in orthorhombic crystalline form (eight-sided ring) (S₈) and has a melting temperature ranging from 120° C. to 124° C. Said elemental sulfur in orthorhombic crystalline form (S₈), at a temperature above 159° C., is subject to ring opening polymerization (ROP) and is transformed into a linear polymer chain with two free radicals at the ends. Said linear polymer chain is metastable and therefore tends, more or less slowly depending on the conditions, to revert into the orthorhombic crystalline form (S₈).

For the purpose of the process that is the subject of the present invention, said elemental sulfur is in orthorhombic crystalline form (S₈), said form being, generally, the most stable, the most accessible and the least expensive. However, it should be noted that, for the purpose of the present invention, the other allotropic forms of sulfur may also be used, such as, for example, cyclic allotropic forms resulting from thermal processes to which elemental sulfur can be subjected in an orthorhombic crystalline form (S₈). It should also be noted that any species of sulfur which, when heated, makes it possible to obtain species which are capable of undergoing radical or anionic polymerization, can be used for the purpose of the process which is the subject of the present invention.

As mentioned above, said elastomeric copolymer with a high sulfur content can be advantageously used in a great many applications such as, for example, thermal insulation, conveyor belts, transmission belts, flexible hoses, elastomeric compositions for tyres.

Consequently, the use of said elastomeric copolymer with a high sulfur content in a great many applications such as, for example, thermal insulation, conveyor belts, transmission belts, flexible hoses, elastomeric compositions for tyres, is a further subject of the present invention.

In order to better understand the present invention and to put it into practice, the following are some illustrative and non-limiting examples thereof.

### EXAMPLES

### Analysis and Characterization Methodologies

The analysis and characterization methodologies below reported have been used.

### Thermal Analysis (DSC)

The DSC (Differential Scanning calorimetry) thermal analysis, in order to determine the glass transition temperature (T_{g}) of the copolymers obtained, was carried out by means of a Perkin Elmer Pyris differential scanning calorimeter, using the following thermal programme:

cooling from ambient temperature (T=25° C.) to −60° C. at a rate of −5° C./minute;
heating from −60° C. to +150° C. at a rate of +10° C./minute (first scan);
cooling from +150° C. to −60° C. at a rate of −5° C./minute;
heating from −60° C. to +150° C. at a rate of +10° C./minute (second scan); working under a nitrogen (N₂) stream at 70 ml/minute.

### Example 1 (Invention)

### Synthesis of Elastomeric Copolymer With Sulfur (70% by Weight) and Diallyl Diselenide (30% by Weight)

7 g of pure sulfur [elemental sulfur in the orthorhombic crystalline form (S₈) of Sigma-Aldrich] was charged into a 60 ml glass autoclave equipped with a magnetic stirrer: the autoclave was heated to 160° C. and maintained at said temperature for 10 minutes, thus obtaining the melting of the sulfur, which becomes a yellow liquid. 3 g of liquid diallyl diselenide (Sigma-Aldrich) was then added, drop by drop, to said liquid: the whole was maintained, under stiffing, at 160° C., for 3 minutes, obtaining a solution which remains still fluid and takes on an intense red colour. The fluid solution thus obtained was poured into a Teflon mould that was closed and heated to 120° C. in an oven: said fluid solution was maintained at said temperature for 12 hours, obtaining an elastomeric copolymer black in colour and with translucent appearance.

Said elastomeric copolymer was subjected to DSC (Differential Scanning calorimetry) thermal analysis, working as described above, for the purpose of measuring the glass transition temperature (T_{g}) which was found to be equal to −8° C.

Said elastomeric copolymer was also subjected to elongation at break, determined in accordance with the ISO 37:2017 standard, which was found to be equal to 67%.

### Example 2 (Invention)

### Synthesis of Elastomeric Copolymer With Sulfur (70% by Weight) and Garlic Essential Oil (30% by Weight)

7 g of pure sulfur [elemental sulfur in the orthorhombic crystalline form (S₈) of Sigma-Aldrich] was charged into a 60 ml glass autoclave equipped with a magnetic stirrer: the autoclave was heated to 160° C. and maintained at said temperature for 10 minutes, obtaining the melting of the sulfur, which becomes a yellow liquid. 3 g of liquid garlic essential oil (having the following composition: diallyl disulphide 50% by weight, diallyl trisulphide 13% by weight, allyl sulphide 9%, other compounds 28% by weight—Naissance) was then added, drop by drop, to said liquid: the whole was maintained, under stiffing, at 160° C., for 3 minutes, obtaining a solution which remains still fluid and takes on an intense red colour. The fluid solution thus obtained was poured into a Teflon mould that was closed and heated to 120° C. in an oven: said fluid solution was maintained at said temperature for 12 hours, yielding an elastomeric copolymer black in colour and with translucent appearance.

Said elastomeric copolymer was subjected to DSC (Differential Scanning calorimetry) thermal analysis, working as described above, for the purpose of measuring the glass transition temperature (T_{g}), which was found to be equal to −16° C.

Said elastomeric copolymer was also subjected to elongation at break, determined in accordance with the ISO 37:2017 standard, which was found to be equal to 74%.

### Example 3 (Invention)

### Synthesis of Elastomeric Copolymer With Sulfur (80% by weight) and Divinyl Disulphide (20% by Weight)

8 g of pure sulfur [elemental sulfur in the orthorhombic crystalline form (S₈) of Sigma-Aldrich] was charged into a 60 ml glass autoclave equipped with a magnetic stirrer: the autoclave was heated to 160° C. and maintained at said temperature for 10 minutes, obtaining the melting of the sulfur, which becomes a yellow liquid. 2 g of liquid divinyl disulphide (Sigma-Aldrich) was then added, drop by drop, to said liquid: the whole was maintained, under stiffing, at 160° C., for 3 minutes, obtaining a solution which remains still fluid and takes on an intense red colour. The fluid solution thus obtained was poured into a Teflon mould that was closed and heated to 120° C. in an oven: said fluid solution was maintained at said temperature for 12 hours, obtaining an elastomeric copolymer black in colour and with translucent appearance.

Said elastomeric copolymer was subjected to DSC (Differential Scanning calorimetry) thermal analysis, operating as described above, for the purpose of measuring the glass transition temperature (T_{g}), which was found to be equal to −8° C.

Said elastomeric copolymer was also subjected to elongation at break, determined in accordance with the ISO 37:2017 standard, which was found to be equal to 82%.

### Example 4 (Invention)

### Synthesis of Elastomeric Copolymer With Sulfur (70% by Weight) and Divinyl Disulphide (30% by Weight)

7 g of pure sulfur [elemental sulfur in the orthorhombic crystalline form (S₈) of Sigma-Aldrich] was charged into a 60 ml glass autoclave equipped with a magnetic stirrer: the autoclave was heated to 160° C. and maintained at said temperature for 10 minutes, obtaining the melting of the sulfur, which becomes a yellow liquid. 3 g of liquid divinyl disulphide (Sigma-Aldrich) was then added, drop by drop, to said liquid: the whole was maintained, under stiffing, at 160° C., for 3 minutes, obtaining a solution, which remains still fluid, and takes on an intense red colour. The fluid solution thus obtained was poured into a Teflon mould that was closed and heated to 120° C. in an oven: said fluid solution was maintained at said temperature for 12 hours, obtaining an elastomeric copolymer black in colour and with translucent appearance.

Said elastomeric copolymer was subjected to DSC (Differential Scanning calorimetry) thermal analysis, working as described above, for the purpose of measuring the glass transition temperature (T_{g}), which was found to be equal to −12° C.

Said elastomeric copolymer was also subjected to elongation at break, determined in accordance with the ISO 37:2017 standard, which was found to be equal to 63%.

1. Elastomeric copolymer with a high sulfur content, comprising sulfur in a quantity higher than or equal to 40% by weight with respect to the total weight of said elastomeric copolymer, and at least one monomer having general formula (I):
CH₂═CH—(CH₂)_{y}-(X)ₙ-(X)ₘ-(CH₂)ₓ—CH═CH₂ (I)
wherein:
X represents a sulfur atom, a selenium atom, a tellurium atom;
y and x, equal to or different from one another, are a whole number ranging from 0 to 4;
n and m, equal to or different from one another, are a whole number ranging from 0 to 3, at least one of n and m being equal to 1;
said monomer being present in a quantity lower than or equal to 60% by weight with respect to the total weight of said elastomeric copolymer;
provided that, in the case wherein said general formula (I) X is sulfur, y and x are 1, at least one of n and m must be different from 1 and the sum of n+m must be different from 1.

2. Elastomeric copolymer with a high sulfur content according to claim 1, wherein said monomer having general formula (I) is selected from diallyl diselenide, garlic essential oil, divinyl disulphide, or mixtures thereof.

3. Elastomeric copolymer with a high sulfur content according to claim 1, wherein said elastomeric copolymer with a high sulfur content comprises sulfur in a quantity equal to 70% by weight with respect to the total weight of said elastomeric copolymer and at least one monomer having general formula (Ia):
CH₂═CH—(CH₂)_{y}-(X)ₙ-(X)ₘ-(CH₂)ₓ—CH═CH₂ (Ia)
wherein:
X represents a selenium atom;
y is 1;
x is 1;
n is 1; and
m is 1, and
wherein said monomer being present in a quantity equal to 30% by weight with respect to the total weight of said elastomeric copolymer.

4. Elastomeric copolymer with a high sulfur content according to claim 1, wherein said elastomeric copolymer with a high sulfur content comprises sulfur in a quantity equal to 70% by weight with respect to the total weight of said elastomeric copolymer and a mixture of monomers having general formula (Ib):
CH₂═CH—(CH₂)_{y}-(X)ₙ-(X)ₘ-(CH₂)ₓ—CH═CH₂ (Ib)
wherein:
X represents a sulfur atom;
y is 1;
x is 1;
n is 0 or 1; and
m is 1 or 2, and
wherein said mixture of monomers being present in a quantity equal to 30% by weight with respect to the total weight of said elastomeric copolymer.

5. Elastomeric copolymer with a high sulfur content according to claim 1, wherein said elastomeric copolymer with a high sulfur content comprises sulfur in a quantity equal to 80% by weight with respect to the total weight of said elastomeric copolymer and at least one monomer having general formula (Ic):
CH₂═CH—(CH₂)_{y}-(X)ₙ-(X)ₘ-(CH₂)ₓ—CH═CH₂ (Ic)
wherein:
X represents a sulfur atom;
y is 0;
x is 0;
n is 1; and
m is 1, and
wherein said monomer being present in a quantity equal to 20% by weight with respect to the total weight of said elastomeric copolymer.

6. Elastomeric copolymer with a high sulfur content according to claim 1, wherein said elastomeric copolymer with a high sulfur content comprises sulfur in a quantity equal to 70% by weight with respect to the total weight of said elastomeric copolymer and at least one monomer having general formula (Ic):
CH₂═CH—(CH₂)_{y}-(X)ₙ-(X)ₘ-(CH₂)ₓ—CH═CH₂ (Ic)
wherein:
X represents a sulfur atom;
y is 0;
x is 0;
n is 1; and
m is 1, and
wherein said monomer being present in a quantity equal to 30% by weight with respect to the total weight of said elastomeric copolymer.

7. Elastomeric copolymer with a high sulfur content according to claim 1, wherein said elastomeric copolymer with a high sulfur content has a glass transition temperature (T_{g}) higher than or equal to −20° C.

8. Elastomeric copolymer with a high sulfur content according to claim 1, wherein said elastomeric copolymer with a high sulfur content has an elongation at break higher than or equal to 55%.

9. Process for the preparation of an elastomeric copolymer with a high sulfur content comprising:
(i) melting the sulfur at a temperature ranging from 110° C. to 190° C. for a time ranging from 1 minute to 15 minutes obtaining sulfur in liquid form;
(ii) reacting the sulfur in liquid form obtained in stage (i) with at least one monomer having general formula (I) at a temperature ranging from 110° C. to 190° C. for a time ranging from 1 minute to 15 minutes obtaining a liquid pre-polymer; and
(iii) pouring the liquid pre-polymer obtained in stage (ii) into a mould and maintaining said mould at a temperature ranging from 100° C. to 150° C. for a time ranging from 1 hour to 20 hours obtaining an elastomeric copolymer with a high sulfur content.

10. Process for the preparation of a thermoplastic copolymer with a high sulfur content according to claim 9, wherein the sulfur used in said stage (i) is elemental sulfur.

11. Use of an elastomeric copolymer with a high sulfur content according to claim 1, in thermal insulation, conveyor belts, transmission belts, flexible hoses, or elastomeric compositions for tyres.

12. Elastomeric copolymer with a high sulfur content according to claim 1, wherein the sulfur is present from 55% by weight to 90% by weight.

13. Elastomeric copolymer with a high sulfur content according to claim 1, wherein X represents a sulfur atom.

14. Elastomeric copolymer with a high sulfur content according to claim 1, wherein said monomer is present from 10% by weight to 45% by weight.

15. Elastomeric copolymer with a high sulfur content according to claim 1, wherein the T_{g} is from 18° C. to 10° C.

16. Process for the preparation of a thermoplastic copolymer with a high sulfur content according to claim 9, wherein the sulfur is melted at a temperature from 120° C. to 170° C., wherein the sulfur in liquid form is reacted at a temperature ranging from 120° C. to 170° C. for a time ranging from 2 minutes to 10 minutes, and wherein the liquid pre-polymer is poured and said mould is maintained at a temperature ranging from ranging from 110° C. to 130° C. for a time ranging from 2 hours to 15 hours.
